(19) United States
(12) Patent Application Publication
(10) Pub. No.: US 2017/0023984 A1
(43) Pub. Date: Jan. 26, 2017

(54) TORSION BAR DESIGN

(71) Applicant: Apple Inc., Cupertino, CA (US)

(72) Inventor: Scott J. Krahn, Cupertino, CA (US)

(21) Appl. No.: 14/806,578

(22) Filed: Jul. 22, 2015

(51) Int. Cl. G06F 1/16; E05D 11/00; E05D 1/00

(52) U.S. Cl. CPC G06F 1/1681; E05D 1/00; E05D 11/00

(57) ABSTRACT

A torsion bar assembly including a number of torsion bars is disclosed. The torsion bar assembly is configured to provide an assistive biasing force to hinged components of an electronic device. The loading of the torsion bar assembly can include combined bending and torsional loading of the individual torsion bars. The torsion bar assembly can be used in conjunction with a hinge assembly, such that the torsion bars add and/or subtract a desired amount of resistance to the hinge assembly. The hinge assembly can include a hollow bore region, through which the torsion bar assembly can pass.

### FIELD

The described embodiments relate generally to computer devices. More particularly, the present embodiments relate to the use of torsion bar assemblies to exert a biasing force between hinged components in such computing devices.

### BACKGROUND

Hinge assemblies are often used to allow components of a computing devices to move relative to one another. For example, a laptop computing device can be formed of a base component that is coupled to an upper display component such that the base component and upper display component share a common axis of rotation defined by a hinge assembly. It is often desirable to provide an assistive biasing force when moving the upper component of the laptop between closed and open positions. Unfortunately, a conventional friction-based hinge assembly provides a fixed resistance over a range of motion of the hinge assembly. Consequently, any variations made in the amount of resistance applies to the entire range of motion and cannot be targeted to particular portions of the range of motion or in particular directions.

### SUMMARY

This paper describes various embodiments that relate to torsion bar assemblies suitable for adjusting a resistance of pivotally coupled components.

A torsion bar assembly is disclosed that is suitable for pivotally coupling a first component to a second component of an electronic device. The torsion bar assembly includes torsion bars aligned with a common axis of rotation of the first and second components. The torsion bars have a first end coupled with the first component by way of a first securing element, and a second end coupled with the second component by way of a second securing element. Relative rotation of the first and second components with respect to each other and about the common axis of rotation induces an amount of twisting of the secured torsion bars resulting in a force that tends to oppose the relative movement of the first and second components.

A clutch assembly that pivotally couples a first component and a second component of an electronic computing device includes a first clutch component secured to the first component, a second clutch component secured to the second component and a number of torsion bars coupled to the first clutch component by a first securing element and to the second clutch component by a second securing element such that a relative movement of the first and second components about a common axis of rotation induces a rotational deformation of each of the torsion bars that resists the movement.

A method of applying an assistive force between components of a hinged electronic device is described that includes at least the following operations: coupling first ends of torsion bars to a first component such that the first ends rotate with the first component around a common axis of rotation defined by a hinge assembly, coupling second ends of the torsion bars to a second component such that the torsion bars are arranged in parallel to the common axis of rotation of the components and relative rotation between the first and second components exerts loading on the torsion bars.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a perspective view of a laptop computing device;

FIG. 1B shows a perspective view of a torsion bar assembly having a single torsion bar;

FIG. 2 shows a graph plotting the induced stress in various torsion bar assemblies as they are rotated through an angle of rotation;

FIGS. 3A-3B show perspective views of a two bar torsion bar assembly;

FIGS. 4A-4B show cut-away views of three bar torsion bar assemblies;

FIG. 4C shows a cut-away view of a four bar torsion bar assembly;

FIGS. 4D-4F show cut-away views of torsion bar assemblies having bars with varying cross-sectional sizes;

FIGS. 5A-5C show perspective exploded views of various ways in which a torsion bar can be coupled to a securing elements of a torsion bar assembly;

FIG. 6 shows a perspective view of a hinge assembly coupled to a torsion bar assembly;

FIGS. 7A-7B show perspective views of a hollow hinge assembly integrated with a torsion bar assembly; and

FIG. 8 shows a flow chart describing a method for attaching a torsion bar assembly to an electronic device.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to mechanical components suitable for pivotally coupling various components of an electronic device. The mechanical components can take the form of hinges. While a friction-based hinge allows pivotally coupled components of the electronic device to be maintained in any number of angular positions with respect to one another, the friction-based hinge generally provides only a consistent amount of force throughout an angular travel of the friction based hinge, i.e. the response force profile of a friction-based hinge is a constant resistive force. To vary an amount of force supplied in response to rotation of the pivotally coupled components, a torsion bar can be added to the friction-based hinge to provide one means for changing an amount of force required when rotating various portions of an electronic device. This may be desirable when the amount of force required during rotation in one direction is desired to be noticeably less than the amount of force required during rotation in another direction. Similarly, this may also be desirable when the amount of force required during rotation is desired to vary with the angle of rotation, thereby producing a varied response force profile.

Unfortunately, a torsion bar assembly that includes only one torsion bar can get prohibitively long when a design requires the torsion bar assembly to supply large amounts of force and/or angular rotation. When the length of a single bar torsion bar assembly is reduced without reducing the amount of force supplied in response to twisting the torsion bar, the amount of shear stress induced in the torsion bar is greatly increased. An increase in the shear stress induced in the torsion bar significantly reduces a range of motion that can be achieved by the torsion bar without damaging the torsion bar. Inducing shear stresses that approach or are greater than a yield strength limit of the torsion bar material can plastically deform the torsion bar, causing the torsion bar to become permanently deformed and eventually fail after enough cycles.

One way to design a torsion bar assembly having a desired size, force response, and range of motion is to utilize a torsion bar assembly that includes multiple torsion bars. By increasing the number of torsion bars in the torsion bar assembly, a reduction in the overall length and shear stress within each of the torsion bars can be reached at the cost of only a slight increase in the overall diameter of the torsion bar assembly, while maintaining the same force response. Other properties of the torsion bar assembly that can be adjusted to help optimize the torsion bar assembly include material composition of the torsion bars, the cross-sectional shape of the torsion bars, and the arrangement of the torsion bars with respect to an axis of rotation.

In some embodiments, one end of a torsion bar assembly is coupled to a base component of an electronic device such that one end of each of the torsion bars remains stationary relative to the base component. An opposite end of the torsion bar assembly is secured to an upper component of the electronic device such that the opposite end of each of the torsion bars remain stationary relative to the upper component. The torsion bars can be arranged parallel to each other, and in some embodiments each torsion bar is parallel to a common axis of rotation of the base component and the upper component. Rotation of the upper component relative to the base component subjects the torsion bar assembly to a torsional force as the torsion bar assembly is twisted by the rotation of the components with respect to one another.

In some embodiments, the torsion bars assembly includes securing elements for affixing the torsion bar assembly to the base component and the upper component. Opposing ends of each torsion bar are coupled to the upper component and the base component by way of the securing elements. Once secured to one of the components, each securing elements prevents a respective end of the torsion bars from rotating relative to the component the securing element is coupled to. In some embodiments, the individual torsion bars can be integrally formed with the securing elements during the manufacture of the torsion bars. Alternatively, the securing elements may be adhered to or otherwise mechanically coupled to the ends of the torsion bars. In some embodiments, the securing elements are integrally formed with a hinge assembly or component of an electronic device such as a base component or display component of a laptop computing device. In some embodiments, the ends of the torsion bars can have keying features that mechanically interlock with the securing elements to prevent rotation of the torsion bars with respect to the securing elements. In some embodiments, a securing element is affixed to a component in a way that allows for axial movement of the securing element relative to the axis of rotation during rotation of the components. The axial movement can prevent axial loading of the torsion bar assembly caused by the torsion bars wrapping or unwrapping about one another during torsional loading and unloading.

In further embodiments, the torsion bar assembly can be configured to adjust a resistance of a hinge assembly that defines a common axis of rotation between an upper component and a base component of an electronic device. The hinge assembly can be a friction clutch hinge assembly that exerts a uniform frictional force resistance opposing any relative rotation of the upper component relative to the base component. The torsion bar assembly and the friction clutch hinge assembly can cooperate to provide a desired feel when rotating the upper component relative to the base component. The friction clutch hinge assembly can allow the upper component to remain in a desired position relative to the base component once an external force is no longer being exerted upon the upper component. It should be noted that the torsion bars can have a cross section of various geometries. For example, the cross section can be circular, elliptical, rectangular, square, triangular, etc.

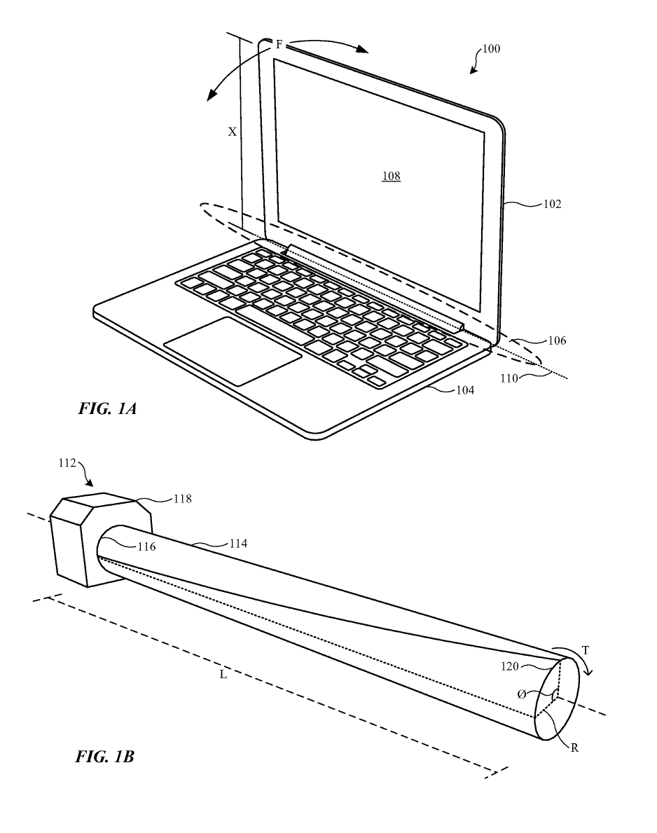

These and other embodiments are discussed below with reference to FIGS. 1A-8. However, those skilled in the art will readily appreciate that the detailed description given herein with respect to these Figures is for explanatory purposes only and should not be construed as limiting.

FIG. 1A shows exemplary computing device 100 suitable for use with the described embodiments. Computing device 100 can include upper component 102 and a base component 104. Upper component 102 can house a display 108, electronics for controlling display 108, and other electrical elements. Base component 104 can house a keypad, trackpad, integrated circuits, a battery and other electrical elements suitable for operating computing device 100. Upper component 102 is pivotally coupled to base component 104 by a hinge assembly located within intersection 106 of upper component 102 and base component 104. The hinge assembly can define a common axis of rotation 110 about which upper component 102 can be pivotally rotated relative to base component 104. The hinge assembly can be a friction clutch hinge assembly that resists the application of force “F” on the upper component at a distance “X” from the axis of rotation 110 during relative rotation of upper component 102 with respect to base component 104. As described above, friction based hinge assemblies only provide a constant resistance in response to force “F” applied in either of the depicted directions.

A torsion bar assembly can be used within intersection 106 to vary an amount of force “F” required to pivot the upper component 102 relative to the base component 104. The torsion bar assembly can be configured to undergo torsional loading or unloading when the upper component 102 is rotated relative to the base component 104. As the torsion bar assembly undergoes increasing amounts of loading to resist the force “F” being applied to upper component 102 the resistance gets progressively larger with the angular rotation of the upper component 102 relative to the base component 104. As a result, if the torsion bar assembly is in an unloaded state when upper component 102 is oriented as depicted, then the torsion bar assembly can exert only minimal amounts of force when a user wants to make small adjustments to an angle at which the screen is oriented. However, when rotating upper component 102 into contact with base component 104 an amount of resistance provided by the torsion bar assembly can be maximized. This can be beneficial as it can provide additional force that can prevent inadvertent closure of computing device 100. Another advantage of this configuration is that when computing device 100 is opened, the torsion bar assembly is being unloaded as upper component 102 is rotated away from base component 104, which allows the torsion bar to reduce an amount of resistance to opening computing device 100. In this way the torsion bar makes the device easier to open than to close. It should be noted that when the torsion bar assembly includes a single torsion bar, a desired amount of resistance of the torsion bar assembly may require a torsion bar assembly that is larger than an amount of space available within intersection 106. Specifically, the length of a torsion bar assembly having a sufficient range of motion and resistance can be larger than desired. Reduction of the size of the torsion bar assembly while maintaining a desired amount of added or subtracted resistance can reduce the effective angle of rotation, or range of motion that the torsion bar assembly is capable of rotating through while maintaining the integrity of the torsion bar assembly as discussed below with respect to FIG. 1B.

FIG. 1B shows a perspective cross-sectional view of torsion bar assembly 112 that includes torsion bar 114 having length “L”. In this embodiment, torsion bar 114 has a uniform radius “R” along the length “L” of torsion bar 114. The torsion bar 114 is coupled at an immobilized end 116 to a securing element 118 that prevents movement of the coupled end when the free end 120 of torsion bar 114 is subjected to torque “T”. When torsion bar 114 is formed from a uniform material, the torque “T” required to rotate free end 120 through an angle of rotation “0” can be modeled by the following equation where “G” represents the shear modulus of the material that has a fixed value related to the stiffness of the uniform material:

$$T = \frac{∅ \times G \times π \times {R}^{4}}{2 \times L} \qquad Eq ( 1 )$$

As can be readily derived from Eq (1), the torque “T” required to rotate free end 120 through an angle of rotation “θ” is linearly proportional to the inverse of length “L” of torsion bar 114 and proportional to the radius “R” of the torsion bar to the fourth power. Eq (1) further shows that the torque (T) obeys Hooke's law for springs and that a solid cylindrical torsion bar has an angular spring rate “k” defined as:

$$k = \frac{G \times π \times {R}^{4}}{2 \times L} \qquad Eq ( 2 )$$

The spring rate “k” of torsion bar assembly 112 determines the amount of resistance provided by torsion bar assembly 112 when subjected to torsional loading. When the spring rate “k” is constant, the resistance exerted by torsion bar assembly 112 is linearly proportional to the angular rotation “θ” of free end 120 of the torsion bar 114. When a torsion bar has a larger spring rate “k” it can provide a larger response force for a given angle of rotation “θ”.

As can be derived from Eq(1) and Eq(2), a desired response force profile of torsion bar 114 can be maintained when reducing the length “L” of the single torsion bar 114 by a specified percentage while correspondingly decreasing the radius “R” of torsion bar 114 by a substantially smaller percentage. The reduction in length “L” and proportionally smaller decrease in radius “R”, however, result in an undesirable increased shear stress induced in torsion bar 114 for a given angle of rotation “θ” when compared to a longer torsion bar 114. This increased shear stress can reduce the effective range of motion of torsion bar 114.

Eq (3) shows that the shear stress “τ” experienced by a torsion bar 114 is linearly proportional to both the shear modulus “G” of the material and the radius “R” and inversely linearly proportional to the length “L” of torsion bar 114 for a given angle of rotation “θ” as shown in the following equation:

$$τ = \frac{∅ \times G \times R}{L} \qquad Eq ( 3 )$$

As the shear stress induced in torsion bar 114 reaches the yield strength limit of the torsion bar material, torsion bar 114 can become permanently deformed and can eventually fail after enough cycles. Further, repeated high stress cycling of torsion bar 114 near the yield strength limit can fatigue the torsion bar material, which can also result in degradation and eventually failure of torsion bar 114. This fatiguing compounds during repeated use of torsion bar 114, as is typical in computer devices where torsion bar 114 may be required to undergo upwards of 50,000 cycles. This compounding fatiguing of torsion bar 114 reduces the life cycle of torsion bar assembly 112. While a reduction in the angle of rotation through which torsion bar 114 is allowed to rotate can reduce the induced shear stress within torsion bar 114, this reduction may prevent the torsion bar from allowing a satisfactory range of motion for the pivotally coupled components of the device.

As can be derived from the above equations, a reduction in the length “L” of a single torsion bar 114 while maintaining a desired response force profile for a given angle of deflection “θ” of the torsion bar assembly 112 will require an undesirable increase in shear stress “τ” experienced by torsion bar 114. This is because maintaining a desired spring rate “K” while reducing the length “L” of the torsion bar 114 requires a proportionally smaller decrease in the radius “R” of the torsion bar which increases the shear stress “τ”.

As should be evident from the above equations governing design modifications of a torsion bar assembly 112, options for reducing size can be very limiting. By using a torsion bar assembly with multiple torsion bars a reduction in both the length “L” of the torsion bar assembly and/or a decrease in the shear stress “τ” experienced be each of the torsion bars 114 may be achieved while maintaining the desired response force profile of the torsion bar assembly. This is because the shear stress is experienced individually by each of the torsion bars in the torsion bar assembly, allowing the response force of each of the individual torsion bars to contribute cumulatively to the response force of the torsion bar assembly. Referencing Eq (3), the radius “R” of each of the individual torsion bars in the torsion bar assembly can be reduced, thereby reducing the shear stress “τ” induced in each individual torsion bar. A torsion bar assembly that includes multiple torsion bars can generate the same amount of resistance as a torsion bar assembly with a single torsion bar while undergoing substantially less shear stress. The overall diameter of a torsion bar assembly with multiple torsion bars tends to be slightly greater than a torsion bar assembly with a single torsion bar providing a similar amount of resistance. The overall increase in diameter for the multi-bar torsion bar assembly depends on the arrangement of the torsion bars. Depending on design goals and constraints, a balance of reduction in length “L” of the torsion bar assembly, increase in radius “R” of the torsion bar assembly, and reduction in shear stress “τ” induced in each of the torsion bars for a given angular of the torsion bar assembly can be achieved while maintaining a desired amount of resistance.

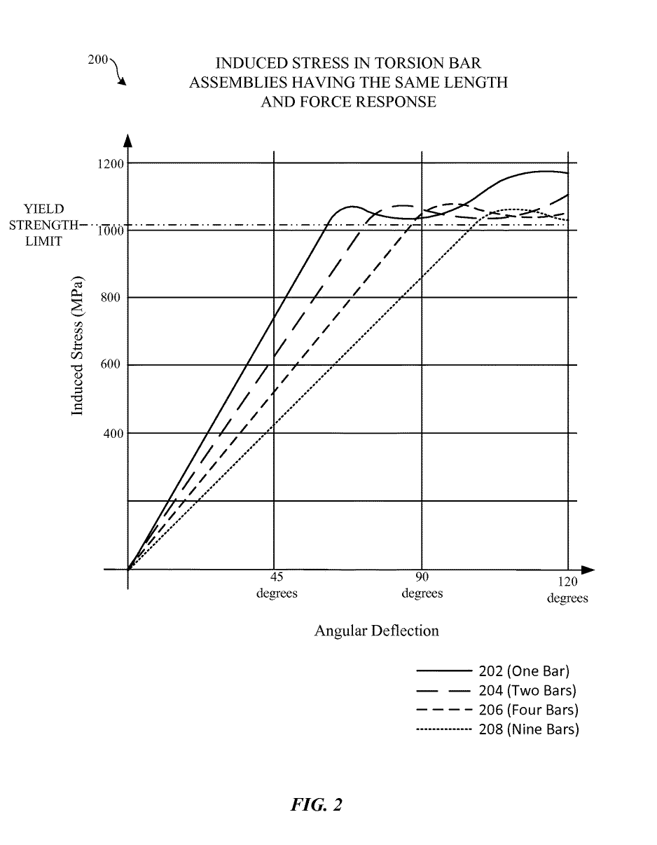

FIG. 2 shows a graph 200 plotting the induced stress in various exemplary embodiments of torsion bar assemblies against the angular rotation “θ” of the various exemplary torsion bar assemblies. The graph illustrates a reduction in induced shear stress that is achievable through the use of a torsion bar assembly with multiple torsion bars. The various exemplary torsion bar assemblies have equal lengths and equal response force profiles within the working range of the torsion bar assemblies, i.e., the exemplary torsion bar assemblies provide equal response forces through the angular rotation of the torsion bar assemblies up to the angle at which the induced stress within the torsion bars equals the yield strength limit of the torsion bar material. For exemplary purposes only, the torsion bars in each exemplary torsion bar assembly are constructed of spring steel (ASTM 666) having a shear modulus of 80 GPa, and a max shear stress or yield strength limit of 1014 MPa, corresponding to a stress at which plastic deformation of the torsion bar begins. It should be noted that other materials can be used to form the torsion bars including stainless steel, aluminum, brass, carbon fiber, rubber, various polymers and carbon-fiber reinforced polymers. Each of the various torsion bar assemblies have a length of three inches and provide a resistance of about one pound of force in response to a force exerted approximately nine inches from the axis of rotation as the torsion bar assembly is rotated through an angle of rotation of 60 degrees from an unloaded position of the torsion bar assembly. In some embodiments, nine inches can correspond to a height of an exemplary laptop display. For a system in which a total amount of angular deflection is desired to be at least 180 degrees and the torsion bar assembly is in a neutral position halfway through this angular deflection, a system in which the torsion bar assembly does not elastically deform within an angular displacement of 90 degrees will not meet the desired specification.

Graph 200 shows that a torsion bar assembly having a single torsion bar will reach the yield strength limit of a spring steel torsion rod, 1014 MPa, at an angular deflection of about 68 degrees. Twisting this torsion bar assembly beyond an angular deflection of about 68 degrees will result in plastic deformation of the torsion bar, at which point the torsion bar becomes less reliable and more likely to experience a torsion bar failure. Rotational deformation of the torsion bar assembly below 68 degrees will result in elastic deformation of the individual torsion bars, such that the individual torsion bars return to their original shape when the torque is removed. A torsion bar assembly that includes two torsion bars of the same length and supplying the desired force response may be deflected about 81 degrees before reaching the yield strength limit of the individual torsion bars. A torsion bar assembly with four torsion bars, again of the same length and having the desired force response, may be deflected 97 degrees before reaching the yield strength limit of the individual bars. A torsion bar assembly with nine torsion bars of the same length and having the desired force response may be angularly deflected 120 degrees before reaching the yield strength limit of the individual bars.

As can be derived from graph 200, a considerable reduction in the induced shear stress can be achieved through the use of torsion bars assemblies having higher numbers of torsion bars while maintaining a desired force response of the torsion bar assembly. While these exemplary embodiments maintained a constant length for each of the torsion bar assemblies, the length, arrangement, and radii of the individual torsion bars within each of the torsion bar assemblies can be modified to achieve a satisfactory balance of induced shear stress, overall diameter, length, and desired force response of a torsion bar assembly.

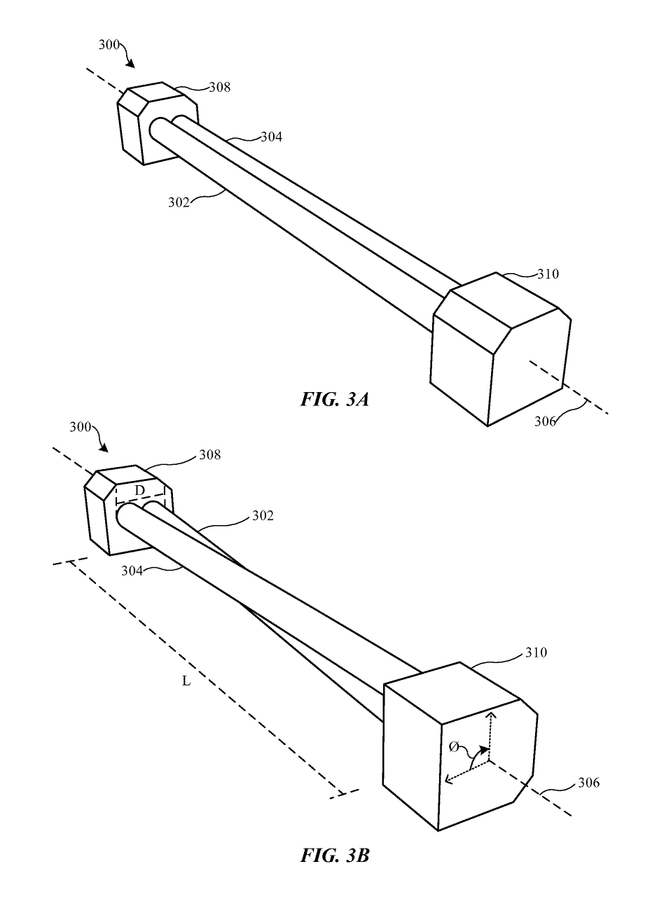

FIGS. 3A-3B show perspective views of a torsion bar assembly 300. In some embodiments, torsion bar assembly 300 includes torsion bars 302 and 304. Torsion bars 302 and 304 are arranged parallel to each other and are aligned with axis of rotation 306. The torsion bars can be of equal length and ends of the torsion bars 302 and 304 are coupled to securing elements 308 and 310. In some embodiments, the securing elements may be integrally formed with torsion bars 302 and 304. In other embodiments, securing elements 308 and 310 can be integrally formed with a hinge assembly. In some embodiments, securing elements 308 and 310 can be coupled to adjacent components of an electronic device. Securing elements 308 and 310 can be arranged in any combination of the above described embodiments. In some embodiments, axis of rotation 306 may be defined by a hinge assembly coupling components of an electronic device. Torsion bar assembly 300 can be aligned with axis of rotation 306 in a way that positions axis of rotation 306 evenly between torsion bars 302 and 304.

The choice of material for torsion bars 302 and 304 can be varied to modify the shear modulus “G” of torsion bars 302 and 304. The material will determine the force response profiles and induced shear stress of torsion bars 302 and 304. A material having a higher shear modulus “G” will increase the stiffness and spring rate “k” of individual torsion bars 302 and 304 and provide a larger response force profile of torsion bar assembly 300. Correspondingly, torsion bars 302 and 304 formed of a material having a lower shear modulus “G” require either larger radii “R” and/or shorter lengths “L” to maintain a desired force response profile as shown in Eq. (2) above. Materials suitable for use as torsion bars 302 and 304 include iron, tool steel, spring steel, stainless steel, aluminum, brass, rubber, polymers, and carbon-fiber-reinforced polymer. Materials such as spring steel have a high modulus “G” and can allow for smaller diameter torsion bars 302 and 304 for a given spring rate “K”. In some embodiments torsion bars 302 and 304 are formed of the same material. By using the same or similar materials to form torsion bars 302 and 304 unnecessary variables that add additional stresses can be eliminated. For example, variations in thermal expansion as well as uneven distribution of shear stress between the torsion bars can be avoided.

In some embodiments, the yield strength of torsion bars 302 and 304 may vary radially. For example, torsion bars 302 and 304 may have a higher yield strength in an outer layer than a central layer of torsion bars 302 and 304. This radial variance in the yield strength can be a result of work hardening of torsion bars 302 and 304. The work hardening can occur during of the manufacturing process of torsion bars 302 and 304 or an additional process intended to alter the material of torsion bar 302 and 304. A work hardened portion of torsion bars 302 and 304 will have a higher yield strength. Since the induced shear stress of torsion bars 302 and 304 increases with radial distance from the axis of rotation and is highest at an outer layer, an increase in the yield strength of an outer layer of torsion bars 302 and 304 can increase the overall yield strength limit of torsion bars 302 and 304. This increase yield strength limit can allow for a further reduction in the size of torsion bar assembly 300.

In some embodiments, torsion bars 302 and 304 are cold worked to form the cylindrical shape of torsion bars 302 and 304. The cold working alters the crystalline structure of a circumferential outer layer of torsion bars 302 and 304. The depth of the work hardened circumferential layer can depend on the specific process used to form torsion bars 302 and 304. A volumetric percentage of torsion bars 302 and 304 that is work hardened can depend on the radii “R” of torsion bars 302 and 304 and depth “d” of the work hardening layer. Smaller radius “R” torsion bars 302 and 304 having a work hardened layer of depth “d” will have a larger percentage of their volume work hardened than larger radius torsion bars having a work hardened layer of an equal depth “d”. This increase in the yield strength of torsion bars 302 and 304 further decreases the relative shear stress that torsion bars 302 and 304 experience during use resulting in a longer cycle life of torsion bars 302 and 304.

The response force of torsion bar assembly 300 can be further modified by varying the cross-sectional shapes of torsion bars 302 and 304. In some embodiments, torsion bars 302 and 304 have circular cross-sections. In some embodiments, torsion bars 302 and 304 are hollow, and define a central bore region extending through each of the torsion bars. While torsion bars 302 and 304 may have any cross-sectional shape, cylindrical torsion bars 302 and 304 have certain advantages over other cross-sectional shapes. Shear stress induced in a cylindrical torsion bars 302 and 304 is distributed evenly over cylindrical torsion bars 302 and 304 preventing warping, or non-symmetric deformation, of torsion bars 302 and 304 when they are subjected to torsional loading. Torsion bars 302 and 304 having non-cylindrical cross-sections can concentrate shear stress in areas of torsion bars 302 and 304 due to warping of their cross-sectional shape. These stress concentrations can lead to localized fatiguing and failure of the torsion bars.

Another advantage of cylindrical torsion bars 302 and 304 is that cylindrical torsion bars 302 and 304 can be easily polished, reducing surface imperfections that can concentrate stress and cause fatiguing that can lead to degradation and failure of the torsion bars 302 and 304. Torsion bars 302 and 304 can be polished during the manufacture of torsion bars 302 and 304 or during assembly of torsion bar assembly 300. In some embodiments, torsion bars 302 and 304 are in contact along the length of the torsion bars 302 and 304. When the torsion bar assembly 300 is subjected to torsional loading, torsion bars 302 and 304 can be drawn over each other as shown in FIG. 3B.

FIG. 3B shows a perspective view of a torsion bar assembly 300 under load. When securing element 310 is rotated through an angle of rotation “θ” around an axis of rotation 306 relative to securing element 308, torsion bars 302 and 304 undergo combined torsion and bending loading. The force response exerted on securing element 310 in response to rotating securing element 310 through the angle of rotation “θ” is a combination of the torsional loading and bending loading of torsion bars 302 and 304. In a torsion bar assembly where the length “L” is much greater than the radius “R” and the axis of rotation is proximate central axes of individual torsion bars 302 and 304, the loading of torsion bars 302 and 304 from bending or deflection is minimal compared to the torsional loading in torsion bars 302 and 304. Similarly, the induced shear stress induced in torsion bars 302 and 304 due to bending is minimal compared to the torsional induced shear stress in torsion bars 302 and 304 when the axis of rotation is proximate central axes of torsion bars 302 and 304. The loading of torsion bar assembly 300, therefore, can be approximated by evaluating the torsional loading and torsional induced stress in each individual torsion bar for explanatory purposes.

In some embodiments, axis of rotation 306 of torsion bar assembly 300 is not positioned evenly between torsion bars 302 and 304. In such a configuration, torsion bars 302 and 304 undergo unequal bending loading as securing element 310 is rotated relative to securing element 308. Torsion bar 302 is subjected to a different amount of deflection than torsion bar 304. Torsion bar 302 can be arranged such that the deflection induced in torsion bar 302 is not minimal when compared to the torsional loading of torsion bars 302 and 304. The additional loading due to bending can reduce a required torsional loading of torsion bars 302 and 304, thus facilitating a reduction in the required radii of torsion bars 304 and 304. This reduction in the radii of torsion bar 302 and 304 can allow for a reduction in the overall diameter “D” of the torsion bar assembly 300.

In addition to undergoing torsional loading and deflection, torsion bars 302 and 304 can also undergo axial loading as they are drawn over and wrap around one another. As torsion bars 302 and 304 are drawn over each other the effective length “L” between securing elements 308 and 310 is reduced when securing elements 308 and 310 are not secured axially. In some embodiments, the securing elements 308 and 310 are secured axially, inducing axial loading as torsion bar assembly 300 is loaded. This axial loading can further contribute to the response force profile of torsion bar assembly 300. The additional response force provided by the axial loading of torsion bars 302 and 304 can facilitate a further reduction in the size of torsion bar assembly 300 since the required torsional and bending loading is reduced.

In some embodiments, ends of the torsion bars 302 and 304 are allowed to translate axially to relieve axial loading that occurs when the torsion bars 302 and 304 are drawn over one another. In some embodiments a securing element, either securing element 308 or 3010, allows the coupled torsion bars to translate axially within the securing element. In some embodiments the torsion bar ends are immobilized within securing elements 308 and 310 and either securing element 308 or securing element 310 is allowed to translate axially to relieve axial loading of torsion bar assembly 300. In some embodiments, both securing elements 308 and 310 are configured to translate axially to reduce axial loading of torsion bar assembly 300.

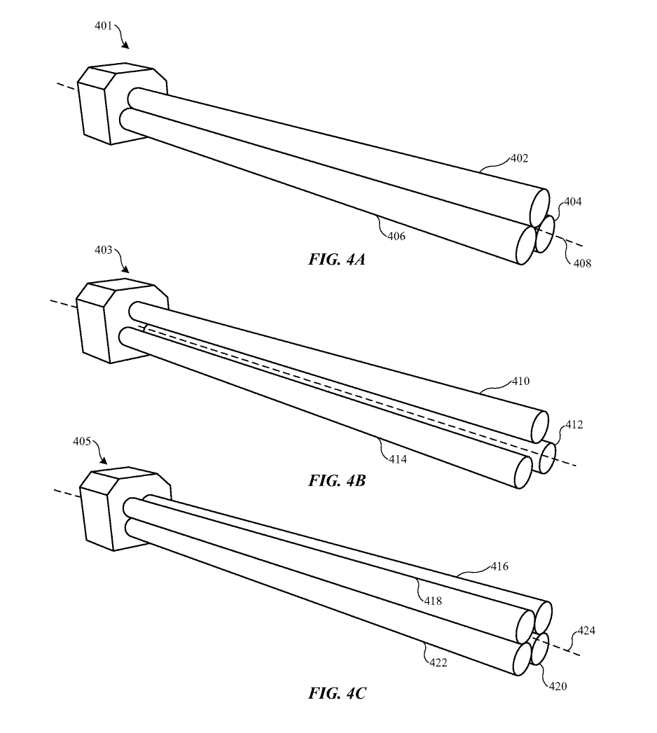

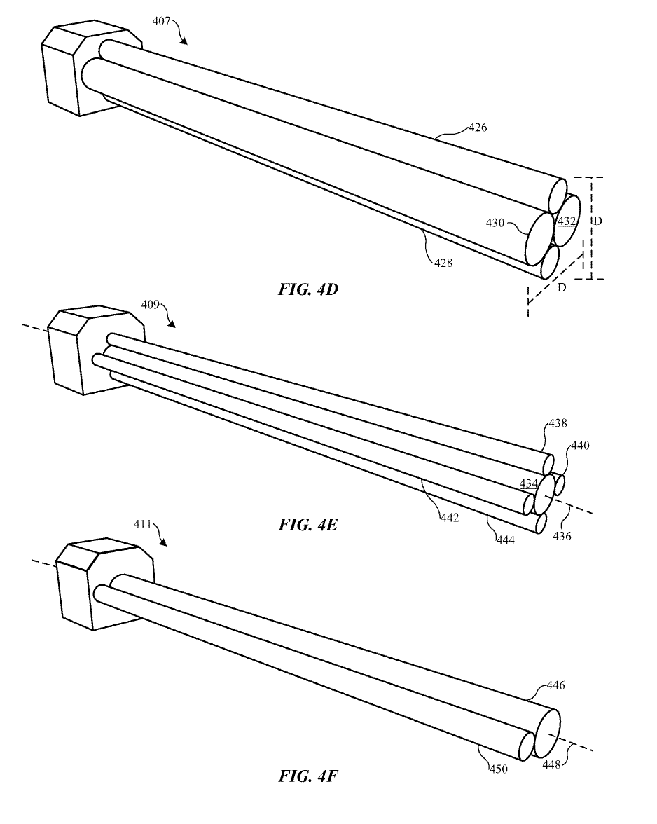

To further modify the spring rate and response of a torsion bar assembly, the number of torsion bars, the relative diameters of the torsion bars, and the arrangement of the torsion bars with respect to the axis of rotation can be modified as shown in FIGS. 4A-4F. FIGS. 4A-4F show perspective cross-sectional views of torsion bar assemblies. Any number of torsion bars in a torsion bar assembly can be used to modify the spring rate, size, and yield stress of the torsion bar assembly. FIG. 4A shows a perspective cross-sectional view of torsion bar assembly 401 having three torsion bars 402, 404, and 406 in parallel. Torsion bars 402, 404, and 406 are arranged such that they are in contact along their length and an equal distance from an axis of rotation 408.

FIG. 4B shows a perspective cross-sectional view of an embodiment of torsion bar assembly 403 having torsion bars 410, 412 and 414 that are not in contact along their length. As torsion bar assembly 403 is subjected to a torsional load, torsion bars 410, 412 and 414 are subjected to a bending load. The bending load draws the torsion bars 410, 412 and 414 toward each other. In some embodiments, torsion bar assembly 403 is configured such that torsion bars 410, 412 and 414 remain separated when torsion bar assembly 403 is rotated through a working range of rotation. The working range of rotation is defined by the angle through which pivotally coupled components are free to rotate, and thus subject torsion bar assembly 403 to loading.

In some embodiments, torsion bars 410, 412, and 414 are arranged such that the response force profile of torsion bar assembly 403 is not linearly proportional to the angle of rotation throughout the working range of torsion bar assembly 403. Torsion bars 410, 412 and 414 are configured to come into contact during torsional loading of torsion bar assembly 403 within the working range of rotation. As torsion bar assembly 403 is rotated torsion bars 410, 412, and 414 are drawn towards the axis of rotation and at a predetermined angle torsion bars 410, 412, and 414 contact one another. As torsion bars 410, 412 and 414 contact each other during rotation of torsion bar assembly 403, a bending loading rate for each torsion bar is modified altering the spring rate of torsion bar assembly 403 at this angle of rotation. The response profile of torsion bar assembly 403, therefore, is not linearly proportional to the angle of rotation at this predetermined angle where torsion bars 410, 412, and 414 make contact during rotation. Such a configuration can be advantageous when a substantial increase in resistance is desirable for a particular design.

FIG. 4C shows a perspective cross-sectional view of torsion bar assembly 405 having torsion bars 416, 418, 420 and 422. In some embodiments, four torsion bars 416, 418, 420 and 422 are arranged such that each torsion bar is equally spaced about an axis of rotation 424. Torsion bars 416, 418, 420 and 422 can have equal cross-sectional radii and the loading induced in each bar can be equal. Even distribution of stress between torsion bars 416, 418, 420 and 422 alleviates a concentration of stress in a particular torsion bar that can lead to failure of that particular torsion bar. In an exemplary embodiment a four torsion bar assembly has an equivalent spring rate “k” to a reference torsion bar assembly with a single torsion bar. Further the induced shear stress within each of the torsion bars of the four torsion bar assembly is equivalent to the induced shear stress of the single torsion bar of the reference torsion bar assembly. In this exemplary embodiment, the four torsion bar assembly can have an approximate reduction in length of 37% compared to the reference torsion bar assembly having a single torsion bar. The exemplary four torsion bar assembly will have an overall diameter that is approximately 52% larger than the reference torsion bar assembly.

In some embodiments, torsion bars having varying radii can be arranged in a torsion bar assembly such that the overall diameter of the torsion bar assembly is no greater than a combination of the two largest diameter torsion bars. FIG. 4D shows a perspective cross-sectional view of torsion bar assembly 407 having torsion bars 426, 428, 430 and 432 of varying radii and an outer diameter “D” that is equal to a combination of the two largest diameter torsion bars, 430 and 432. Torsion bars 426 and 428 have a smaller radii than torsion bars 430 and 432. The arrangement and radii of torsion bars 426 and 428 can be configured such that an overall diameter “D” of torsion bar assembly 407 is not increased over a torsion bar assembly having only torsion bars 430 and 432.

In some embodiments one of the torsion bars can be aligned with the axis of rotation of the torsion bar assembly. FIG. 4E shows a perspective cross-sectional view of torsion bar assembly 409 where a central axis of one of the torsion bars, torsion bar 434, is aligned with the axis of rotation 436 of the torsion bar assembly 409. Under loading of torsion bar assembly 409, torsion bar 434 undergoes torsional loading while torsion bars 438, 440, 442 and 444 undergo at least a combined torsional and bending load.

In some embodiments, torsion bars can be arranged such that the loading of the torsion bar assembly is asymmetric. The spring rate and response of a torsion bar assembly can be modified through asymmetrically shifting the bending and torsional loads induced in the torsion bars around the axis of rotation. FIG. 4F shows a perspective cross-sectional view of torsion bar assembly 411 having one torsion bar 446 with its central axis aligned with the axis of rotation 448, and another torsion bar 450 parallel to the axis of rotation 448 and in contact with torsion bar 446.

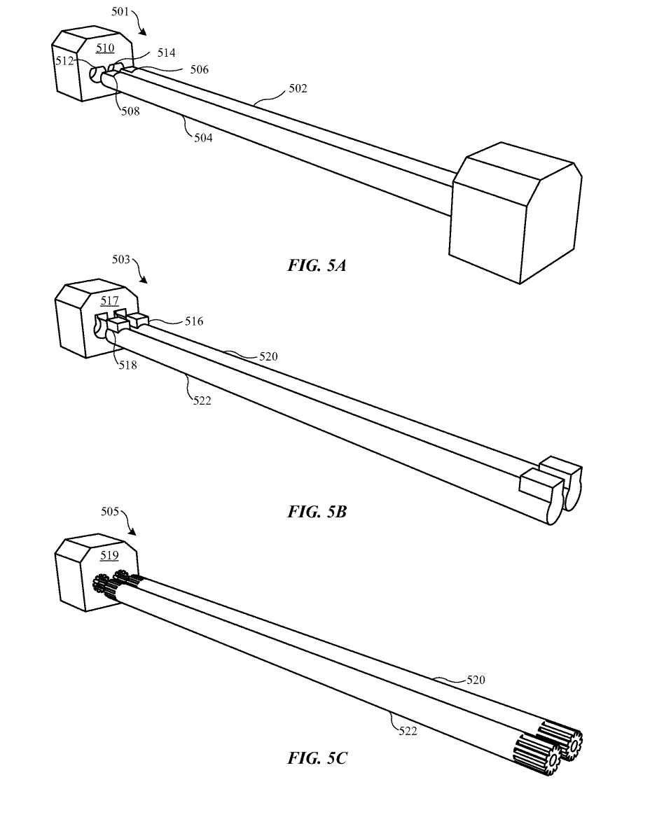

In some embodiments torsion bars are restrained by securing elements that are configured to couple the torsion bar assembly to opposing major components of an electronic device. Torsion bars can be coupled to the securing elements in any way that prevents rotation of the torsion bars when the torsion bar assembly is subjected to a torsional load. Securing methods can include adhesive, press fitting, and features designed into the torsion bars and corresponding securing elements. In some embodiments, the torsion bars can have engagement features that are configured to couple the torsion bars to the securing elements. FIGS. 5A-5C show perspective views of torsion bar assemblies having engagement features. FIG. 5A shows a perspective exploded view of torsion bar assembly 501 where ends of torsion bars 502 and 504 have engagement elements 506 and 508. Securing element 510 is configured to receive engagement elements 506 and 508 at engagement slots 512 and 514 to prevent rotation of torsion bars 502 and 504 when torsion bar assembly 501 is subjected to a torsional load. In some embodiments, engagement elements 506 and 508 are cut into the ends of torsion bars 502 and 504.

Certain engagement element designs can be simpler to manufacture, such as keyed slot engagement elements 506 and 508 that can be formed during the manufacturing process of torsion bars 502 and 504. In some embodiments, engagement elements 506 and 508 are cut into the ends of torsion bars 502 and 504 during the formation of torsion bars 502 and 504. In some embodiments, torsion bars 502 and 504 are configured to be easily decoupled from securing element 510. Decoupling of torsion bars 502 and 504 from securing element 510 can allow for the installation and removal of torsion bar assembly 501. In other embodiments, torsion bars 502 and 504 can be permanently coupled to securing element 510. Torsion bars 502 and 504 can be permanently coupled by glue, adhesive, welding, press fitting, or permanently coupling features.

FIG. 5B shows a perspective exploded view of torsion bar assembly 503 having raised keying features 516 and 518 coupled to torsion bars 520 and 522. In some embodiments, keying features 516 and 518 can be integrated into torsion bars 520 and 522, while in other embodiments keying features 516 and 518 can be coupled to torsion bars 520 and 522. In some embodiments, keying features 516 and 518 are formed onto the ends of torsion bars 520 and 522 through a deformation process that plastically deforms an end region of torsion bars 516 and 518. The deformation process can include a crimping process. In some embodiments, torsion bars 520 and 522 are crimped while engaged with securing element 517, thus permanently coupling torsion bars 516 and 518 to securing element 517. In some embodiments, keying features 516 and 518 can be coupled to torsion bars 520 and 522 by welding, press fitting, or adhesive.

In some embodiments, engagement features may be formed symmetrically around the circumference of the ends of torsion bars to allow for multiple engagement positions. FIG. 5C shows a perspective exploded view of torsion bar assembly 505 having symmetric engagement features 528 and 530 formed at the ends of torsion bars 524 and 526. Any number of symmetric features can be employed to allow for multiple engagement positions of torsion bars 520 and 522 to securing element 519. In some embodiments, engagement features 528 and 530 can be splines that are cut into the ends of torsion bars 524 and 526. Any number of splines may be employed to couple torsion bars 520 and 522 to securing element 519.

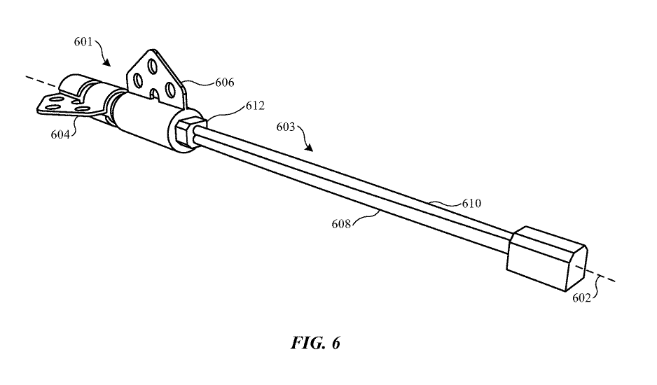

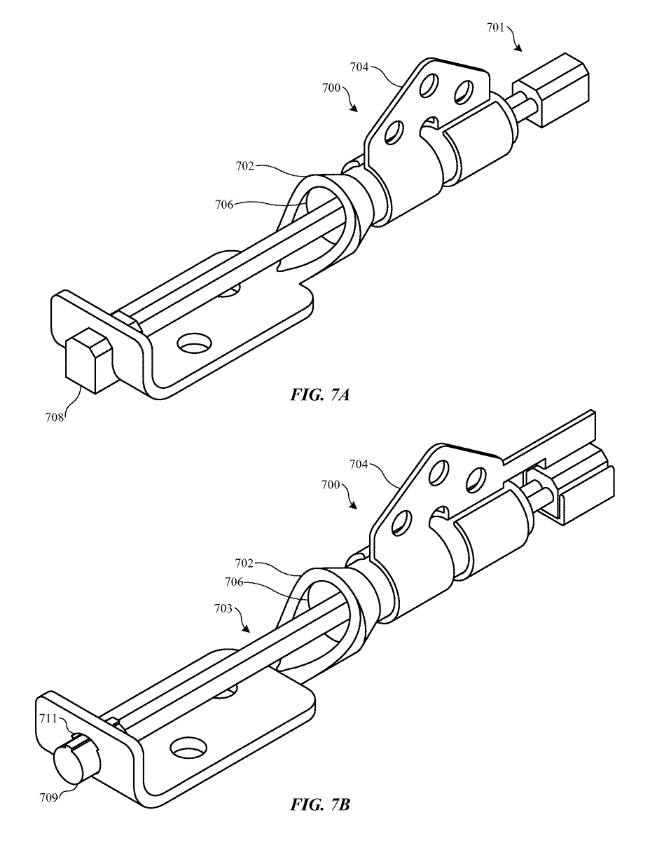

A torsion bar assembly can be combined with a hinge assembly as shown in FIG. 6 which shows a perspective view of a hinge assembly 601 coupled to a torsion bar assembly 603. Hinge assembly 601 can be configured to couple components of an electronic device such that the coupled components of the electronic device share a common axis of rotation 602 defined by hinge assembly 601. Hinge assembly 601 can be a clutch hinge assembly providing a friction force that cooperates with the torsion bar assembly 603 to provide a desired feel to an end user when rotating a first component of the electronic device relative to a second component of the electronic device. In a laptop computing device, for example, the torsion bar assembly 603 and a clutch hinge assembly 601 may exert a force between a base component and a display component of the laptop computing device. Similarly, a clutch hinge assembly 601 and torsion bar assembly 603 can be used between a base and a mounted electronic device. The mounted electronic device can be a display or computer mounted on the base such as an all-in-one computer having a display. In this way, the display or all-in-one computer can tilt with respect to the base providing a resistance customized by addition of torsion bar assembly 603. Torsion bar assembly 603 and clutch hinge assembly 601 can be arranged such that a spring force exerted by the torsion bar assembly 603 assists a user when moving the components of the electronic device around the hinge assembly 601 into a desirable orientation.

In some embodiments, clutch hinge assembly 601 includes an outer clutch component 604 configured to house an inner clutch component 606 such that friction between the inner clutch component 606 and the outer clutch component 604 modifies a user feel of the hinge assembly. Outer clutch component 604 is coupled to a first component of an electrical device, and inner clutch component 606 is coupled to a second component of the electrical device such that the first and second major components share an axis of rotation 602. Clutch hinge assembly 601 can provide a consistent force against the relative rotation of major components of an electronic device. First ends of torsion bars 608 and 610 can be coupled to a portion of clutch hinge assembly 601 that is secured to a first component of an electronic device and second ends of torsion bars 608 and 610 are coupled to a second component of the electronic device such that relative motion between the major components loads the torsion bar assembly 603.

Torsion bar assembly 603 can include securing element 612 at a first end of torsion bar assembly 603. In some embodiments, outer clutch component 604 can be coupled to securing element 612 such that securing element 612 rotates with outer clutch component 604 when a first major component of an electronic device is rotated. In some embodiments, securing element 612 can be coupled to the inner clutch component 606 such that securing element 612 rotates with inner clutch component 606 when a first major component of the electronic device is rotated. A second end of torsion bar assembly 603 can be coupled to a second major components of the electric device such that the second end rotates with the second major component of the electronic device when major components are rotated around the axis of rotation 602.

In some embodiments, the clutch hinge assembly can have a hollow portion allowing the torsion bar assembly to pass through as shown in FIGS. 7A-7B. FIG. 7A shows a perspective view of a torsion bar assembly 701 combined with a hollow clutch hinge assembly 700. Torsion bar assembly 701 is depicted in a neutral, or unloaded, position. In some embodiments, it can be desirable to have torsion bar assembly 701 pass through a neutral position during relative rotation of pivotally coupled components of a computing device. In a laptop computing device, it can be desirable to have torsion bar assembly 701 pass through a neutral position when a display component is perpendicular to a base component.

In some embodiments, inner clutch component 702 can be circular in nature, and can have an annular outer region and a central bore region 706 surrounded by the annular outer region. The central bore region 706 can be adapted to permit the passage of the torsion bar assembly 701. In some embodiments, torsion bar assembly 701 passes through central bore region 706 and is coupled to the clutch hinge assembly 700. Clutch hinge assembly 700 can be configured to couple to a first end of torsion bar assembly 701. The first end of the torsion bar assembly 701 can include a securing element 708 that couples to inner clutch component 702. In some embodiments, the coupling of securing element 708 to the inner clutch component 702 allows for axial translation of securing element 708 to alleviate axial loading of torsion bar assembly 701 when torsion bar assembly 701 is loaded. A second end of torsion bar assembly 701 is configured such that the second end rotates with the outer clutch component 704.

In some embodiments, the second end of torsion bar assembly 701 is coupled to the outer clutch component 704 as shown in FIG. 7B. In this configuration the combined torsion bar assembly 701 and clutch hinge component 702, act as an isolated unit. Torsional loading of torsion bar assembly 701 can be achieved through the relative rotation of inner clutch component 702 and outer clutch component 704.

In some embodiments, torsion bar assembly 701 is configured to be in an unloaded state in a designated range of rotation of the hinge assembly. The coupling element 711 of securing element 709 can allow for rotation of securing element 709 within this designated range of rotation of the hinge assembly, thereby preventing the loading of the torsion bar assembly within this designated range. In a laptop computing device, for example, torsion bar assembly 701 can be configured to be in an unloaded state when the display of the laptop is rotated in a range between the fully closed and fully open states. The coupling element 711 of the securing element can engage the securing element 709 when the laptop display is proximate the closed and fully open states, thereby providing a biasing assistive force only when the laptop display is proximate the fully closed or fully open states. The friction clutch hinge assembly 700 and the torsion bar assembly 703 can cooperate to produce a response force profile having a neutral range where only the friction clutch hinge assembly contributes to the response force profile.

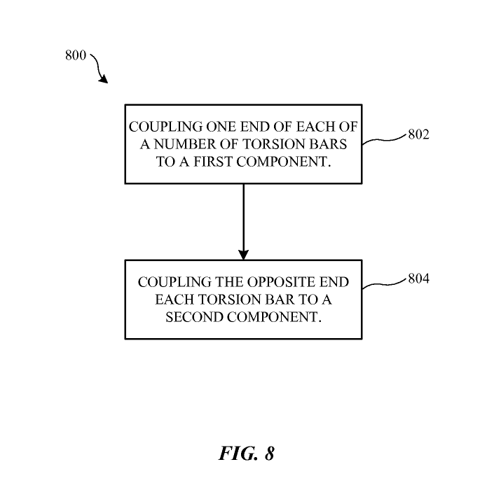

FIG. 8 shows a flow chart describing a method for using a torsion bar assembly. In step 802 one end of each of a number of torsion bars are coupled to a first component. In some embodiments, the ends are coupled directly to the first component. In some embodiments, the first ends are coupled to the component through securing elements that are configured to hold the first ends and prevent rotation of the first ends.

In step 804, an opposite end of each of the torsion bars is coupled to a second component. In some embodiments, the opposite end is coupled directly to the second component, while in other embodiments the opposite end is first coupled to a securing element. The securing element can be made of any material suitable for securely holding the ends of the torsion bars. Suitable materials include steel, aluminum, brass, and copper, and polymers. In some embodiments, the torsion bars are arranged such that they undergo a combined torsional and bending loading when the major components are rotated relative to on another around a common axis. The common axis can be defined by a hinge mechanism that couples the components together.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A torsion bar assembly suitable for a rotational coupling of a first component to a second component, the torsion bar assembly comprising:
a first securing element coupled to the first component;
a second securing element coupled to the second component; and
a collection of torsion bars, each of the collection of torsion bars having a first end coupled to the first securing element and a second end coupled to the second securing element, wherein the collection of torsion bars twist as a group and provide an opposing spring force in response to a rotation of the first and second components with respect to each other.

2. The torsion bar assembly of claim 1, wherein the rotation causes at least one of the collection of torsion bars to undergo both torsional loading and deflection.

3. The torsion bar assembly of claim 1, wherein each of the collection of torsion bars has a circular cross-section and the same diameter.

4. The torsion bar assembly of claim 1, wherein each of the collection of torsion bars are arranged in parallel to and aligned with a common axis of rotation.

5. The torsion bar assembly of claim 1, wherein one of the collection of torsion bars has a different diameter than another one of the collection of torsion bars.

6. The torsion bar assembly of claim 1, wherein the first end of one of the collection of torsion bars includes a keying feature that cooperates with an aperture defined by the first securing element to prevent rotation of the first end of the torsion bar relative to the first securing element.

7. The torsion bar assembly of claim 1, wherein each of the collection of torsion bars are formed of a material selected from the group consisting of iron, tool steel, spring steel, stainless steel, aluminum, brass, carbon fiber, rubber, polymer, and carbon-fiber-reinforced polymer.

8. The torsion bar assembly of claim 1, wherein the collection of torsion bars twist about a common axis of rotation that coincides with a longitudinal axis of one of the collection of torsion bars that does not twist about an axis different from its own longitudinal axis in response to the rotation of the first and second components with respect to each other.

9. The torsion bar assembly of claim 1, wherein the collection of torsion bars includes exactly four torsion bars, each of the four torsion bars being arranged at the same distance from a common axis of rotation.

10. A computing device, comprising:
a first device component;
a second device component pivotally coupled to the first device component; and
a clutch assembly pivotally coupling the first device component and the second device component, the clutch assembly including:
a first securing element coupled to and rotatable together with the first device component,
a second securing element coupled to and rotatable together with the second device component, and
multiple torsion bars coupling the first securing element to the second securing element, wherein the multiple torsion bars collectively provide a spring force against a rotational movement of the first device component with respect to the second device component.

11. The computing device of claim 10, wherein each of the multiple torsion bars are arranged symmetrically about and parallel to a common axis of rotation.

12. The computing device of claim 11, wherein at least one of the torsion bars is cylindrical having a longitudinal axis that is generally parallel to the common axis of rotation.

13. The computing device of claim 10, wherein the multiple torsion bars include exactly four torsion bars.

14. The computing device of claim 10, wherein a central axis of one of the multiple torsion bars is aligned with a common axis of rotation for all of the multiple torsion bars.

15. The computing device of claim 10, wherein the first securing element and the second securing element are coupled to opposite ends of each of the multiple torsion bars.

16. A method of applying a spring force between components of a hinged electronic device, the method comprising:
coupling first ends of multiple torsion bars to a first device component such that the first ends rotate together with the first device component around a common axis of rotation;
coupling second ends of the multiple torsion bars to a second device component such that the multiple torsion bars are arranged in parallel to the common axis of rotation, wherein relative rotation between the first and second device components loads the multiple torsion bars and results in a corresponding spring force from the multiple torsion bars.

17. The method of claim 16, further comprising:
providing securing elements at the first and second ends of the multiple torsion bars.

18. The method of claim 16, further comprising:
coupling the first ends of the multiple torsion bars to a clutch hinge assembly that defines the common axis of rotation.

19. The method of claim 16, further comprising:
polishing the torsion bars to remove surface imperfections that concentrate shear stress.

20. The method of claim 16, further comprising:
aligning a central axis of one of the multiple torsion bars to the common axis of rotation.
